(19) United States
(12) Patent Application Publication
(10) Pub. No.: US 2005/0282139 A1
(43) Pub. Date: Dec. 22, 2005

(54) No Glue Puzzle Frame

(76) Inventor: La Verne Hughes, Columbia, MO (US)

Correspondence Address: La Verne Hughes;RevaL - Designs & More, 2000 E. Broadway, #231, Columbia, MO, 65201, US

(21) Appl. No.: 10/851,744

(22) Filed: May 24, 2004

(51) Int. Cl. G09B 25/00

(52) U.S. Cl. 434/365

(57) ABSTRACT

“Frame Your Puzzle” is the alternative framing method for puzzles, in comparison to what is currently available. Gluing is currently required to frame a jigsaw puzzle in a picture frame. “Frame Your Puzzle” eliminates the need for gluing. This allows the puzzle to be displayed, and later, to be disassembled and placed back in its box for future assembling.

### BACKGROUND OF THE INVENTION

“Frame Your Puzzle” was the brainchild for my son's passion. His enjoyment of putting together jigsaw puzzles, stirred me towards finding a way for him to display his effort and enjoyment. A way that would not only display his finished puzzles, but allow him to disassemble his puzzles, to rework at another time. Years later, after some modifications, I arrived at a simpler method for achieving this goal. That being the convenience of using picture frames, with the necessary components, to allow a puzzle to be displayed, without the use of glue.

Currently, jigsaw puzzlers take their puzzles to a frame shop to have it framed. The frame shop, will then smear glue across the backside of the puzzle, place the puzzle on a mat board, or back board and then border the puzzle with matboard. The puzzle is then placed in the frame to be displayed. Thus, the puzzle can never be reworked again. Puzzle glue is also sold in stores for the jigsaw puzzler to be able to apply it himself. (This can save on money.) “Frame Your Puzzle” allows the puzzle to be displayed, disassembled, then reworked at a later date; or passed on to someone else to work.

### BRIEF SUMMARY OF THE INVENTION

“Frame Your Puzzle” is the answer to the jigsaw puzzlers' dilema for displaying their puzzles. “Frame Your Puzzle” is the first framing system that does not require that the back of the finished puzzle be glued. Now a jigsaw puzzle does not have to be destroyed with glue, but can remain reworkable for the duration of its life.

### DETAILED DESCRIPTION OF THE INVENTION

“Frame Your Puzzle”is an ingenious method for displaying puzzles without destroying them. It consists of:
1. picture frame moulding
2. spring clips
3. sawtooth hangers
4. acrylic plexiglass
5. foam board
6. matboard

These frames come in three different sizes: 18″×24″, 23″×30″, and 30″×42″.

Currently, puzzles to be framed, are taken to a frame shop where they are permanently afffixed with glue to a matboard, or some other backing board, with a matboard border. The drawbacks to this method are the following:
1. The puzzle is permanently assembled.
2. A new frame must be purchased for the next puzzle, unless the old puzzle is to be discarded.
3. A costly method, because of the need to always purchase a new frame for each puzzle to be displayed.
4. Will need to either discard the old puzzles, or find extra room for the additional framed puzzles.

“Frame Your Puzzle” is convenient, less expensive, and does not destroy puzzles.

As mentioned before, there are three sizes:
1. plexiglass size 18″×24″ for puzzle dimensions up to 16″×22″
2. plexiglass size 23″×30″ for puzzle dimensions up to 21″×28″
3. plexiglass size 30″×42″ for puzzle dimensions up to 28″×41″(up to a 2″ border allowance for the matboard to be seen)

With these sizes, puzzles of different dimensions (circular puzzles excluded) can be accommodated by one frame. Different frame mouldings are also possible and available. Metal frames are also available, and do work just as well.

The secret to being able to prevent the puzzle from slipping out of position, while framed, is with the plexiglass and the spring clips. The acrylic plexiglass, or any type of plexiglass, has a measure of flexibility. This allows the plexiglass to mold itself around the puzzle. The spring clips are strong, which helps to apply firm pressure against the foam back board. Thus, you have a puzzle that will stay in place without gluing. The swivel action of the spring clips make it simple for the jigsaw puzzler to reach under the framed puzzle, and swivel the clips into the appropriate position to hold the contents securely. At this point, the framed puzzle is ready to be hung up by the sawtooth hanger that is already attached on the back of the flame. One hanger is at the top, and one is on the side. (More spring clips and sawtooth hangers are on the larger frames.)

Using plexiglass has other advantages, such as, less expensive, and it doesn't crack or break like glass does. Scratches can occur, so the person handling it needs to be careful. (The same plexiglass will be handled frequently for changing out the puzzles.)

Matboards, that are used, will be neutral colors, to accommodate the different puzzles to be displayed. Yet, specific colors can be purchased from a frame shop, if desired. The matboard will be the same dimension as the glass, and not cut out as borders. This also allows for different puzzle sizes to be displayed.

To assemble this puzzle frame, the following placement order is required:
1. Assemble the puzzle on a separate piece of flat board (to be lifted up later, to carry the puzzle to the waiting frame).
2. Place the foam board (backboard) on a flat surface, such as a table.
3. Next, place the matboard on top of the foam board.
4. Bring the assembled puzzle over, while it is still on the board it was worked on.
5. Slide the puzzle onto the matboard, then center the puzzle for display.
6. Next, place the plexiglass on top of the puzzle.
7. Add the frame moulding.
8. Reach under the moulding and foam board on each side, and swivel the clips on to the foam board. This holds everything in place.
9. Now, hang the framed puzzle. (No frame shop necessary.)

To remove the puzzle, just reverse the steps; then disassemble the puzzle. Now the frame is ready for the next assembled puzzle. How convenient!

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### SEQUENCE LISTING (when necessary)

“Not Applicable”

### BRIEF DESCRIPTION OF THE SEVERAL VIEWS OF THE DRAWING

(None of the drawings are based on the actual measurements.)

View 1

FIG. 1—picure frame moulding

FIG. 2—acrylic plexiglass

FIG. 3—foam board-front side-white with a styrofoam texture

FIG. 4—foam board-back side-made of cardboard

FIG. 5—matboard

FIG. 6—jigsaw puzzle

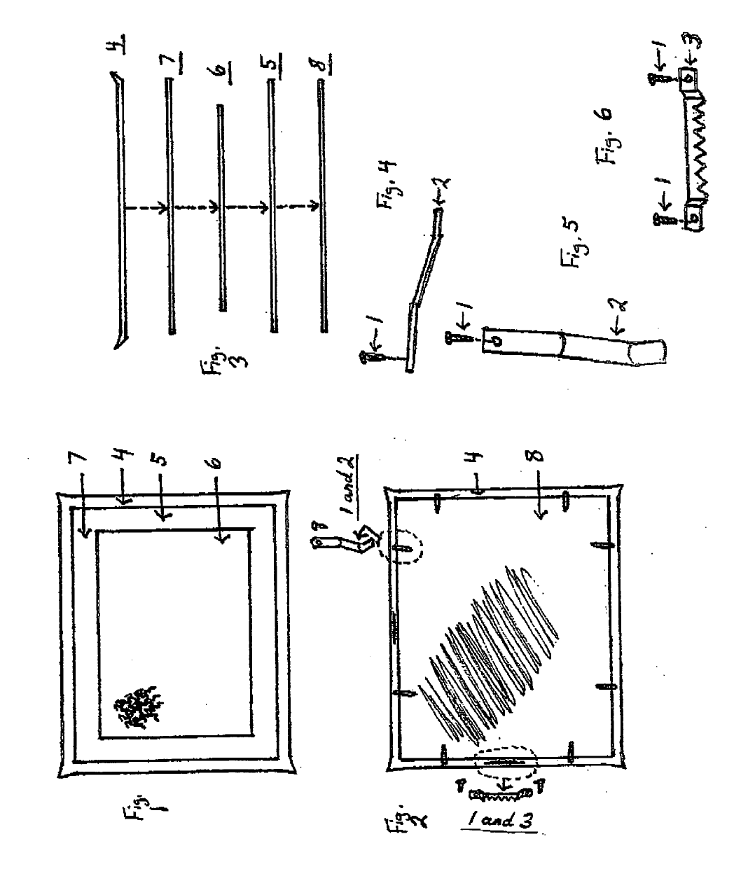

FIGS. 1, 2, 3, 4, and 5 are all based on the plexiglass size. The assortment of sizes are: 18″×24″, 23″×30″, and 30″×42″

FIG. 6 measurements are as follows:

| puzzle size up to - | for plexiglass size - |
|---|---|
| 16″ × 22″ | 18″ × 24″ |
| 21″ × 28″ | 23″ × 30″ |
| 28″ × 41″ | 30″ × 42″ |

View 2

FIG. 7—spring clip-sideview with a screw above the hole in which it goes into, as indicated by the broken lines.

1—screw (measurement is ½″)

2—spring clip with a hole for the screw, at the top (measurement is ⅜″×3⅛″)

FIG. 8—spring clip-aerial view with a screw above the hole in which it goes into, as indicated by the broken lines.

1—(same as in FIG. 7)

2—(same as in FIG. 7)

FIG. 9—sawtooth hanger-with screws above the holes in which they go into, as indicated by the broken lines. (measurement is 3″ long)

1—(same as in FIG. 7)

3—sawtooth hanger with a hole on each side for a screw (measurement is 3″ long)

View 3

FIG. 10—aerial view of the front side of the assembled puzzle frame, with the puzzle in it.

4—picture frame moulding

5—matboard, which is under the puzzle, and is showing through the acrylic plexiglass.

6—assembled puzzle, showing through the acrylic plexiglass

7—acrylic plexiglass covering

FIG. 11—aerial view of the back side of the assembled puzzle frame showing the foam board back, sawtooth hangers, and the spring clips in place.

4—picture frame moulding

8—foam board back

1 and 2—spring clip attached, with screw, to the back of the picture frame moulding

1 and 3—sawtooth hanger attached, with screws, to the back of the picture frame moulding

View 4

FIG. 12—shows the order of assembling the puzzle frame, complete with the puzzle.

4—picture frame moulding placed over

7—the acrylic plexiglass, which is over

6—the puzzle,which is on top of

5—the matboard, which is on top of

8—the foam board

The broken lines, with arrows, indicate which items are placed on top of the others. The order, in which these items are placed for assembling, will be the reverse.

1. A device for framing jigsaw puzzles without the use of glue, comprising of:
a picture frame moulding;
a sheet of acrylic plexiglass;
a sheet of matboard and a sheet of foam board, both having substantially the same dimensions as the sheet of acrylic plexiglass;
a plurality of sawtooth hangers attached to the back of the picture moulding, and adapted to hang the device on a wall; and
a plurality of spring clips which are adapted to provide pressure to the back of the foam board and matboard, such that a jigsaw puzzle can be placed and secured between the acrylic plexiglass and the matboard without the use of glue, and without slipping when the device is hung on a wall.
